(19) United States
(12) Patent Application Publication
(10) Pub. No.: US 2023/0123387 A1
(43) Pub. Date: Apr. 20, 2023

(54) WINDOW-BASED CONGESTION CONTROL

(71) Applicant: Intel Corporation, Santa Clara, CA (US)

(72) Inventors: Robert SOUTHWORTH, Chatsworth, CA (US); Rong PAN, Saratoga, CA (US); Tony HURSON, Austin, TX (US); Siqi LIU, Los Angeles, CA (US)

(21) Appl. No.: 18/082,749

(22) Filed: Dec. 16, 2022

(51) Int. Cl. H04L 47/122; H04L 47/56; H04L 45/00

(52) U.S. Cl. CPC H04L 47/122; H04L 47/562; H04L 45/566

(57) ABSTRACT

Examples described herein relate to a network interface device that includes circuitry to cause transmission of a packet following transmission of one or more data packets to a receiver, wherein the packet comprises one or more of: a count of transmitted data, a timestamp of transmission of the packet, and/or an index value to one or more of a count of transmitted data and a timestamp of transmission of the packet. In some examples, the network interface device includes circuitry to receive, from the receiver, a second packet that includes a copy of the count of transmitted data and the timestamp of transmission of the packet or the index from the packet. In some examples, the network interface device includes circuitry to perform congestion control based on the received copy of the count of transmitted data and the timestamp of transmission of the packet.

### BACKGROUND

Data centers provide vast processing, storage, and networking resources to users. For example, automobiles, smart phones, laptops, tablet computers, or internet of things (IoT) devices can leverage data centers to perform data analysis, data storage, or data retrieval. Devices in data centers are connected together using high speed networking devices such as network interfaces, switches, or routers.

Network congestion control (CC) attempts to reduce congestion from jammed network bandwidth and buffering, by limiting a flow's transmission rate (rate-based), its outstanding unacknowledged packets (window-based), or both. With increased congestion, window-based control limits the amount of sending packets, as acknowledgements are delayed, and bounds an amount of in-flight traffic. In the worst congestion cases, when no feedback from the network is received, window-based control will stop the injection of traffic into the network.

### BRIEF DESCRIPTION OF THE DRAWINGS

FIG. 1 depicts an example system.

FIG. 2 depicts an example operation.

FIG. 3 depicts an example process.

FIG. 4 depicts an example network interface device.

FIG. 5 depicts an example system.

### DETAILED DESCRIPTION

Currently, Remote Direct Memory Access (RDMA) over Converged Ethernet (RoCEv2) protocol does not utilize window-based CC. In particular, when a read operation (a receiver-initiated RDMA transfer) is performed, the Read Response data packets carrying data from target to initiator are considered an acknowledgement of a Read Request, and are not themselves acknowledged. Accordingly, a data sender cannot determine a number or size of packets that are successfully received by the read requester.

To deal with congestion in this case, the DCQCN algorithm in the RoCEv2 protocol proposes to rate control the Read Response by limiting the rate of data transfer based on the amount of Congestion Notification Packets (CNPs) that are sent by the Read Requester and received by the Read Responder. The problem with the rate control scheme is that when the CNP packets are delayed, the Read Responder continues to transmit traffic while the window based scheme would stop sending traffic when the inflight packets exceed the window.

At least to attempt to control the number of packets transmitted through a network to a receiver, a sender can transmit notification packets that indicate an amount of bytes sent since a prior notification packet was sent or an accumulated amount of bytes sent. In some examples, the notification packet can include timestamp of transmission of the notification packets. The sender can send notification packets periodically or after a number of data or control packets have been sent to the receiver. Notification packets should traverse a same path as that of the data packets and may stay in order with data packets in the network. In some examples, notification packets can be sent with or after RoCE Read, Write, or Send packets sent on a given queue pair in a same direction and measure bytes sent to account for packet size variability. In some examples, a separate sender notification packet can be replaced by indications (e.g., one or more of: an amount of bytes sent since a prior notification packet was sent, an accumulated amount of bytes sent, and/or time stamp of packet transmission) added to one or more header fields of one or more data or control packets. The receiver can copy information that includes the indication of amount of bytes sent as well as a timestamp of transmission of the notification packets, and transmit such information to the sender in return notification packets via a same or different path as that used to send the notification packets.

The sender can determine an amount of received or dropped bytes (or other units of measuring data) based on the information. The sender can determine whether latency in a path from sender to receiver is increasing or decreasing and adjust an amount of packets sent to the receiver. The sender can measure round trip time (RTT) and outstanding unacknowledged transmitted bytes based on the return notification packets. The sender can track in-flight (in-network) byte count based on a difference from current transmitted unacknowledged byte count and returned byte count in return notification packets. Some examples can potentially improve stability at least of RDMA congestion control, resulting in lower tail latencies, improved fairness, lower flow completion times, and better network utilization.

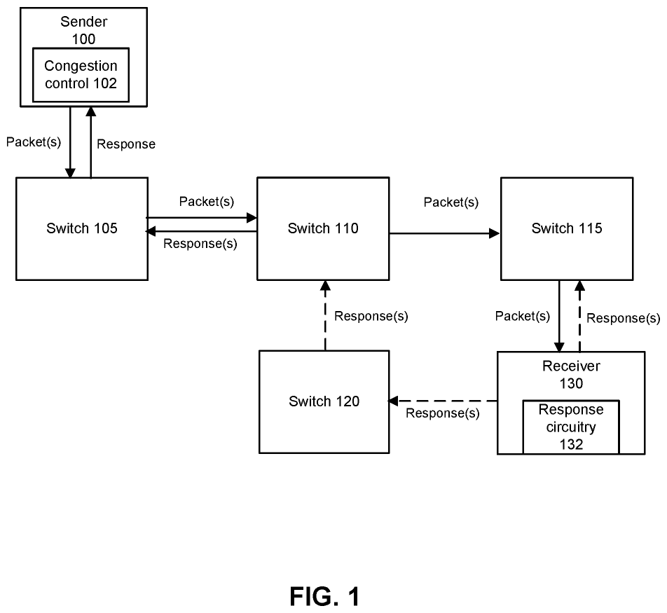

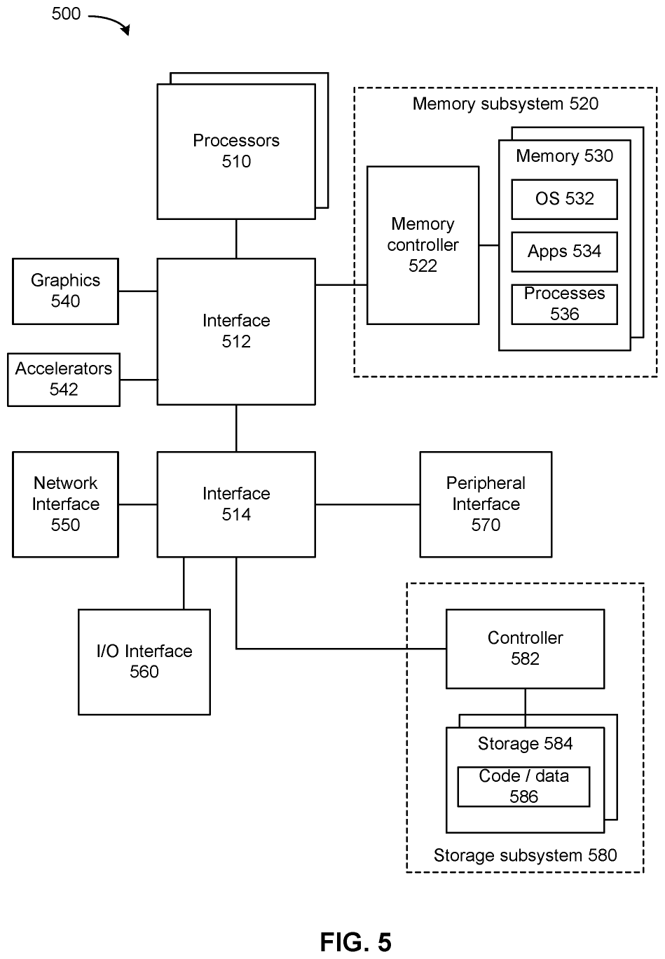

FIG. 1 depicts an example system. Sender 100 can include a network interface device that sends one or more packets to receiver 130, via one or more switches, such as switches 105, 110, and 115, at a request of a host system (not shown). An example of a host system is described with respect to FIG. 5. In some examples, a network interface device can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance. A packet may be used herein to refer to various formatted collections of bits that may be sent across a network, such as Ethernet frames, IP packets, Transmission Control Protocol (TCP) segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

A flow can be a sequence of packets being transferred between two endpoints, generally representing a single session using a protocol. Accordingly, a flow can be identified by a set of defined tuples and, for routing purpose, a flow is identified by the two tuples that identify the endpoints, i.e., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Sender 100 can transmit notification packets or Sender Notification Packets (SNPs) interspersed among data and/or control packets sent to receiver 130. For example, data packets, control packets, and/or SNP can be transmitted as remote direct memory access (RDMA) over Converged Ethernet (RoCE) v2 formats. For example, RoCE v2 is described at least in Annex A17: RoCEv2 (2014). Whereas data and/or control packets sent to receiver 130 can include packet sequence numbers for transmitted packets, notification packets or SNPs can include a byte count-based sequence number (cseq) and timestamp of transmit time of an SNP. In some examples, a cseq can indicate a number of bytes that have been transmitted since a particular time or event or for a particular flow up and including the number of bytes in the cseq. In some examples, a cseq value can indicate a number of payload bytes transmitted in data and/or control packets since a previous transmission of an SNP. For example, a cseq can be 32 bits, although other values can be used. A cseq can be carried in header and/or payload of RoCE-based SNPs. The cseq can be in a different sequence number space as that of transmitted packet sequence numbers for data and/or control packets.

Sender 100 can increase cseq in outbound RoCE Request packets, including duplicates or re-transmits, since they contribute to congestion. Sender 100 may not count header bytes, to reduce ambiguity caused by header manipulation in the network, but a fixed charge per packet may be added to cover header overhead. Accordingly, control packets with no payload may not be counted in cseq.

Sender 100 can utilize congestion control circuitry 102 in network interface device and/or a host to count transmitted data payload bytes using cseq and store cseq into memory. Congestion control circuitry 102 can be implemented as one or more of: field programmable gate array (FPGA), an accelerator, application specific integrated circuit (ASIC), or instruction-executing processor. For example, congestion control circuitry 102 can track, using cseq, a number of bytes transmitted on a given QueuePair (QP). In some examples, transmitted bytes, including re-transmitted bytes, can be tracked. After a certain number of bytes of data, ByteThreshold, are sent on a given QP, congestion control circuitry 102 can cause transmission of an SNP using at least some of the same headers as in the data packets. In some examples, ByteThreshold can be a multiple of bytes, such as a 64 bytes or 32 bytes, or other values. In some examples, sender 100 can send an SNP approximately one or more times per round trip time (RTT), approximately M transmitted data and/or control packets, where M is configured by a driver for congestion control 102, or based on a number of in-flight packets. An RTT can be calculated based on time differences between packet transmissions and indication receipt, such as using the timestamp transmitted using an SNP and returned in an RNP. As described herein, an RNP can include a packet formed to include data of an SNP such as one or more of: an amount of bytes sent since a prior notification packet was sent, an accumulated amount of bytes sent, and/or a timestamp of transmission of the packet.

Data and/or control packets transmitted from sender 100 to receiver 130 can include an incrementing sequence number that is returned in the corresponding response or acknowledgement packet from receiver (RNP) 130. The returned sequence numbers can indicate which data and/or control packets have been received by receiver 130.

In some examples, sender 100 can send one or more SNPs along a same path through a network to receiver 130 as that of data and/or control packets transmitted to receiver 130 in order to probe congestion in a path from sender 100 to receiver 130 through one or more switches or network interface devices. Sender 100 can transmit one or more SNPs using a header format, such as same UDP source port and can be placed in a same traffic class as that of data and/control packets sent to receiver 130. Hence, if receiver 130 receives an SNP, data packets transmitted before the SNP may have either arrived at receiver 130 or been dropped.

Receiver 130 can include a network interface device that received one or more packets as well as a host system (not shown, but an example of a host system is described with respect to FIG. 5). Receiver 130 can utilize response circuitry 132 in a network interface device and/or host to process received SNPs and generate receiver notification packets (RNPs) to transmit to sender 100. Response circuitry 132 can be implemented as one or more of: FPGA, an accelerator, ASIC, or instruction-executing processor. Receiver 130 can copy received cseq and timestamps from SNPs into RNPs and cause the RNPs to be transmitted to sender 100.

In some examples, receiver 130 can adjust information returned via an RNP (or alternative) based on additional events at receiver 130, in a time period between arrival of the SNP (or alternative) and the transmission of the RNP (or alternative). For example, if additional (control or data) packets arrive from sender 100 during this period, the total byte count of these additional packets may be included in the RNP (or alternative) to subtract from the outstanding network byte count [outst_bcnt], and thereby increase the available byte count [cwnd−outst_bcnt]. In some examples, receiver 130 may return this additional byte total to sender 100. In some examples, receiver 130 may add this additional byte total to the rnp_cseq and return the sum in the RNP (or alternative).

In some examples, if the time delay between arrival of SNP (or alternative) and transmission of the RNP (or alternative) is not utilized for congestion control, receiver 130 can adjust the information from SNP (or alternative) returned to ignore that delay. For example, receiver 130 can include a value [ignored_rcvr_delay] in the RNP (or alternative) to be subtracted from the RTT by sender 100 before using the value to identify congestion.

In some examples, receiver 130 may add ignored_rcvr_delay to the timestamp received in an SNP, and return the sum [snp_xmit_timestamp+ignored_rcvr_delay] in an RNP (or alternative). Sender 100 can then subtract this value from a timestamp of receipt of RNP (or alternative) (rnp_recv_timestamp), to determine an adjusted RTT:

$$\begin{matrix}\begin{matrix}\begin{matrix}[ rnp\_recv \_timestamp - \\ ( snp\_xmit \_timestamp +\end{matrix} \\ ignored\_rcvr \_delay ) ]\end{matrix} = ( rnp\_recv \_timestamp - \\ snp\_xmit \_timestamp ) - \\ ignored\_rcvr \_delay \\ = RTT - ignored\_rcvr \_delay\end{matrix} .$$

In some examples, one or more RNPs can be transmitted using a traffic class and path to sender 100 that provides a relatively consistent level of latency and jitter (e.g., variation in latency). For example, a path of one or more RNPs from receiver 130 to sender 100 can traverse switches 120, 110, and 105 or switches 115, 110, and 105. Accordingly, if the timestamp of the SNP is sent back in a low latency, low jitter path (with low to zero delay variation) via a higher priority path, changes in RTT can reflect delay variations in solely outbound path from sender 100 to receiver 130. In some examples, instead of an RNP, one or more data packets can be sent from receiver 130 to sender 100 through the low latency, low jitter path as that of an RNP and the one or more data packets can include one or more of: an amount of bytes sent since a prior notification packet was sent, an accumulated amount of bytes sent, and/or a timestamp of transmission of the one or more data packets.

In some examples, instead of including data (e.g., amount of bytes sent since a prior notification packet was sent, an accumulated amount of bytes sent, and/or a timestamp of transmission of the one or more data packets), in the SNP, the data can be saved at sender 100 or a memory accessible to sender 100 in a table or other format, and the SNP can include a tag (e.g., table index value). The tag could be indicated in the receiver notification packet (RNP) or other packet. Sender 100 could use the received tag to look up the data based on receipt of the RNP or other packet. Such examples can be used in a variety of scenarios including where the SNP and its data are indicated in a field of one or more data packet headers.

Sender 100 can utilize congestion control 102 to measure differences between a current timestamp value, in a time domain of sender 100, and a timestamp value received from an RNP to determine if a path from sender 100 to receiver 130 is becoming more congested, less congested, or remains the approximately the same. Congestion levels in a path can be affected by queue depth of one or more switches in a path, which can lead to latency of packet traversal to receiver 130 or packet drops. As a path of RNPs from receiver 130 to sender 100 can provide an approximately constant level of latency via a higher priority class, changes in congestion and latency of a path from receiver 130 to sender 100 can be approximated from differences between timestamp values at transmission of one or more SNPs from sender 100 and timestamp values at receipt of RNPs that carry timestamp values of the one or more SNPs.

Congestion control 102 can subtract the cseq returned in an RNP from a then-current most recently transmitted byte count (also a cseq) to update a byte count of packets transmitted from sender 100 for which acknowledgement of receipt has not been received, which can reduce in-flight bytes and allow more packets to be sent. Congestion control circuitry 102 can update the congestion window, cwnd, that limits a number of outstanding transmitted bytes for which acknowledgement of receipt has not been received. A congestion window can represent a number of packets or amount of data (e.g., number of bytes) that can be transmitted before receipt of an acknowledgement of packet receipt. Congestion control circuitry 102 can determine an outstanding network byte count, outst_bcnt, which reflects current unacknowledged bytes transmitted from sender 100 to receiver 130 by determining [cseq_sent−rnp_cseq]. In some examples, cseq_sent can represent a number of bytes sent and rnp_cseq can represent a number of bytes received at the receiver, as returned in the RNP cseq. Based on sender 100 determining to send packets to receiver 130, a sent byte count in the packets can be limited to an available byte count given a congestion window, or [cwnd−outst_bcnt]. In some cases, packets without a data payload (such as packet receipt acknowledgements (ACKs)) may not be blocked from transmission by insufficient available byte count. In some examples, data can be sent at a lower level transmission rate even if available byte count is zero or a negative value as SNPs or RNPs could be lost and available byte count not updated.

Note that timestamp value wrap around back to zero can be identified based on increasing byte count values and wrap around can be taken into account in adjusting a returned timestamp value and determining RTT. Similarly, byte count value wrap around back to zero can be identified based on increasing timestamp values and wrap around can be taken into account in adjusting cseq returned in an RNP.

Congestion control 102 can identify changes in RTT to identify changes in switch and endpoint queue depths and congestion. A rising RTT can indicate increasing congestion in a path from sender 100 to receiver 130. A falling RTT can indicate decreasing congestion in a path from sender 100 to receiver 130. Congestion control 102 can adjust cwnd based on changes to RTT. For example, congestion window size can be increased to a congestion window ceiling based on the RTT being stable or falling. For example, congestion window size can be decreased to a congestion window floor based on a rising RTT. The congestion window floor can represent a lower bound send rate and can prevent sender deadlock in scenarios where the congestion window is low and SNP(s) or RNP(s) are lost, leaving the sender with the false impression that bytes are outstanding in the network.

In some examples, congestion control 102 can apply Data Center Quantized Congestion Notification (DCQCN) to control transmit rate of packets based on cseq returned in one or more RNPs. See, e.g., Y. Hu, Z. Shi, Y. Nie and L. Qian, “DCQCN Advanced (DCQCN-A): Combining ECN and RTT for RDMA Congestion Control,” 2021 IEEE 5th Information Technology, Networking, Electronic and Automation Control Conference (ITNEC), 2021, pp. 1192-1198.

In some examples, congestion control 102 can utilize High Precision Congestion Control (HPCC) for remote direct memory access (RDMA) communications that provides congestion metrics to convey link load information. HPCC is described at least in Li et al., “HPCC: High Precision Congestion Control,” SIGCOMM (2019). For example, one or more switches and/or sender 100 can transmit cseq or timestamps to receiver 130 based on HPCC. For example, one or more switches and/or receiver 130 can transmit cseq or timestamps to sender 100 based on HPCC.

For example, one or more switches and/or sender 100 can transmit cseq or timestamps to receiver 130 based on In-band Network Telemetry (INT) (e.g., P4.org Applications Working Group, “In-band Network Telemetry (INT) Dataplane Specification,” Version 2.1 (2020)), Round-Trip-Time (RTT) probes, acknowledgement (ACK) messages, IETF draft-lapukhov-dataplane-probe-01, “Data-plane probe for in-band telemetry collection” (2016), IETF draft-ietf-ippm-ioam-data-09, “In-situ Operations, Administration, and Maintenance (IOAM)” (Mar. 8, 2020). In-situ Operations, Administration, and Maintenance (IOAM) records operational and telemetry information in the packet while the packet traverses a path between two points in the network. IOAM discusses the data fields and associated data types for in-situ OAM. In-situ OAM data fields can be encapsulated into a variety of protocols such as NSH, Segment Routing, Geneve, IPv6 (via extension header), or IPv4. For example, one or more switches and/or receiver 130 can transmit cseq or timestamps to sender 100 based on techniques utilized by sender 100 to transmit cseq or timestamps.

Congestion control 102 can apply other TCP congestion control schemes including Google's Swift, Amazon's SRD, and Microsoft's Data Center TCP (DCTCP), described for example in RFC-8257 (2017). DCTCP is a TCP congestion control scheme whereby when a buffer reaches a threshold, packets are marked with ECN and the end host receives markings and sends the marked packets to a sender. Sender 100 can adjust its transmit rate by adjusting a congestion window (cwnd) size to adjust a number of sent packets for which acknowledgement of receipt was not received. In response to an ECN, sender 100 can reduce a CWND size to reduce a number of sent packets for which acknowledgement of receipt was not received. Swift, SRD, DCTCP, and other CC schemes adjust CWND size based on indirect congestion metrics such as packet drops or network latency.

For some applications, the underlying transport layer is Transmission Control Protocol (TCP). Multiple different congestion control (CC) schemes can be utilized for TCP. Explicit Congestion Notification (ECN), defined in RFC 3168 (2001), allows end-to-end notification of network congestion whereby the receiver of a packet echoes a congestion indication to a sender. A packet sender can reduce its packet transmission rate in response to receipt of an ECN. Use of ECN can lead to packet drops if detection and response to congestion is slow or delayed. For TCP, congestion control 102 can apply congestion control based on heuristics from measures of congestion such as network latency or the number of packet drops.

A congested point (e.g., endpoint, edge, or core switch device) can send a congestion notification packet (CNP) directly or indirectly to sender 100 to reduce its transmit rate and alleviate the congestion situation. Examples of CNP are described at least with respect to DCQCN.

A SNP and/or RNP can be lost during transmission. If an SNP is lost before receipt at receiver 130, a subsequent SNP can include an updated cseq. If loss of an SNP or RNP leads to available window closure (e.g., cwnd−outst_bcnt=0), sender 100 can send, after a configured delay or timeout, to await the RNP arrival, a single outbound Request or Response packet followed by an SNP or merely sending another SNP, to stimulate a window-re-opening RNP to be sent from receiver 130. Sender 100 can then await a window-opening RNP before further packet transmission. If the SNP travels in a same traffic class as outbound Request/Response packets from sender 100, the RNP implies all such packets have been dropped or received. A dormant connection can re-start with potentially old stored RTT measurement, but the RTT can be quickly corrected based on RTT measurements. In some examples, an available window (e.g., cwnd−outst_bcnt) can be set to a configured lower level periodically instead of closing a window from loss of an SNP or RNP.

In some examples, InfiniBand™ Architecture Specification Volume 1 (IBTA) reserved fields of congestion notification packets (CNPs) can be used to transmit SNP and RNP. See, e.g., InfiniBand™ Architecture Specification Volume 1 (2007), and revisions, variations, or updates thereof.

An SNP can follow a last outbound data packet of a flow or a queue pair runs out of packets sent to receiver 130 and receiver 130 can identify a gap in data packets from sender 100 if a next packet sequence number (PSN) is placed in such trailing SNP. If such PSN was not already received by receiver 130, a NACK can be sent to sender 100 to cause re-sending packets with missing PSNs. If data packets are part of a mouse flow and utilize best efforts service level, retransmission of lost packets based on time out can cause unacceptable tail latency. Accordingly, use of trailing SNP can reduce tail latency for packets with missing PSNs. A mouse flow can be a flow with fewer than a configured number of received packets over a configured interval of time.

Note that sender 100 can include response circuitry 132 to process received SNPs. Similarly, receiver 130 can include congestion control 102 to generate SNPs and process received RNPs, as described herein.

Note that protocols other than RoCE can be used to transmit source queue-pair information such as Internet Wide Area RDMA Protocol (iWARP), quick UDP Internet Connections (QUIC), InfiniBand, and others.

Switch 105, 110, and/or 115 can be implemented as one or more of: network interface controller (NIC), SmartNIC, router, top of rack (ToR) switch, switch, forwarding element, infrastructure processing unit (IPU), or data processing unit (DPU).

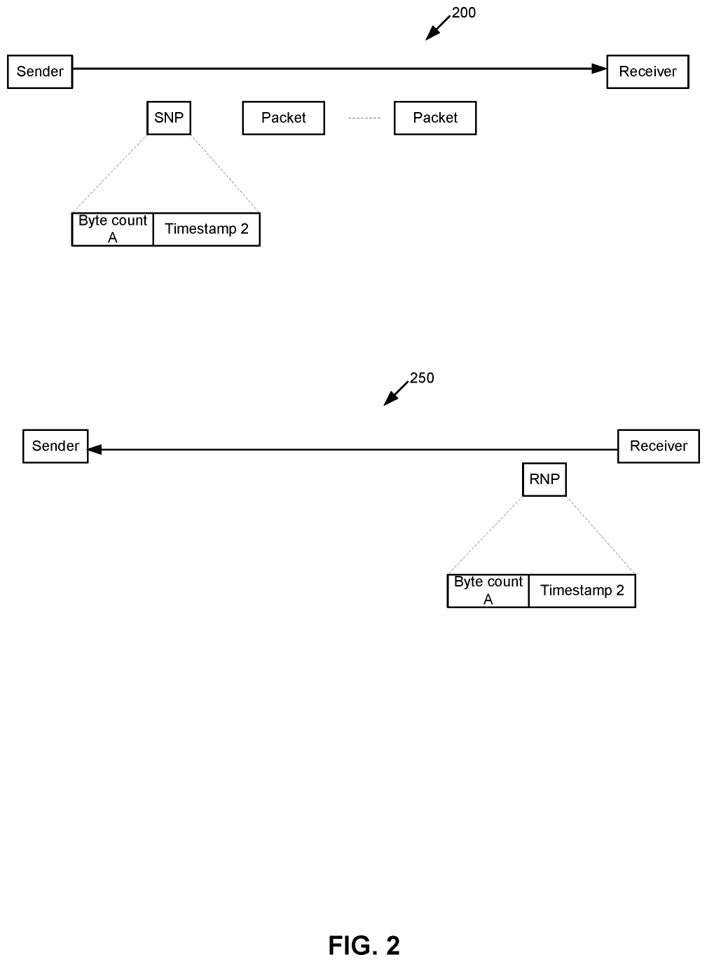

FIG. 2 depicts an example of communications. At 200, a sender can transmit an SNP after one or more data packets or based on expiration of a timer, or other examples, as described herein. In some examples, the SNP can include a byte count of a number of bytes previously transmitted in packets to the receiver as well as a timestamp value of transmission of the SNP. At 250, receiver can copy the byte count and timestamp value from the SNP into an RNP and cause the RNP to be transmitted to the sender. The RNP can traverse a path from receiver to sender that exhibits relatively predictable latency and quality of service.

In some examples, the RoCE CNP format can carry byte count and/or timestamp value in the CNP's 16B reserved field or a different RoCE opcode. In some examples, an InfiniBand Probe Request/Probe Response packet format, currently being defined in the InfiniBand Trade Association Volume 1, can carry the carry byte count and/or timestamp value for SNP and/or RNP. In some examples, byte count and/or timestamp values could potentially be carried in an extra header added to a RoCE packet for SNP and/or RNP.

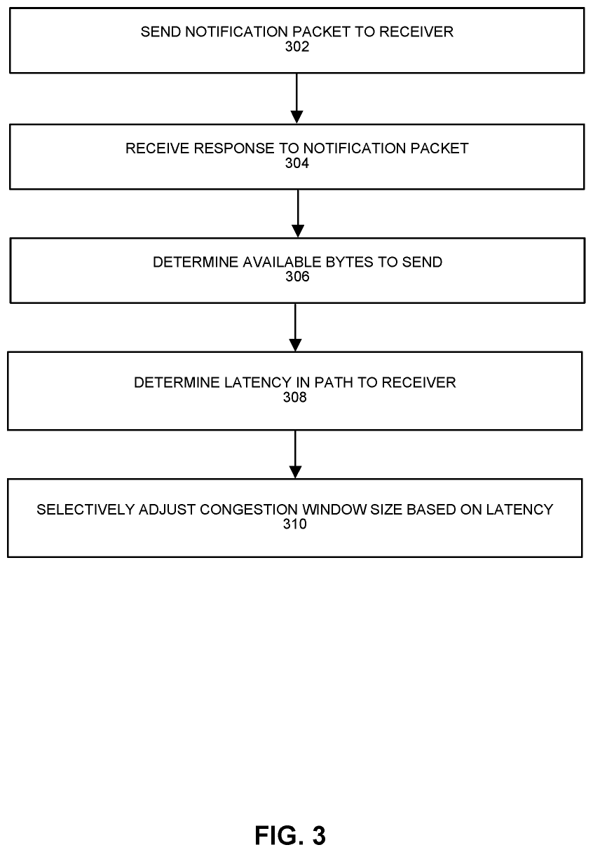

FIG. 3 depicts an example process. The process can be performed by a sender network interface device. At 302, a sender can send a notification packet with accumulated transmitted byte count and timestamp of transmission of the notification packet among or after data traffic to receiver. In some examples, the accumulated transmitted byte count can represent a number of bytes transmitted to the receiver or a number of bytes transmitted to the receiver since a previous notification packet was sent. An example of a notification packet includes an SNP. In some examples, the notification packet can be transmitted along a same path as data and/or control traffic to the receiver.

At 304, the sender can receive a response to notification packet with a copy of the accumulated transmitted byte count and timestamp of transmission of the notification packet. An example of a response to notification packet includes an RNP. In some examples, the response to notification packet can be transmitted in a path to the sender with a predictable latency and jitter or otherwise relatively stable level of latency so that changes in latency of the path from sender to receiver can be determined.

At 306, the sender can determine available bytes to send based on the received accumulated transmitted byte count and a congestion window size. For example, the received accumulated transmitted byte count can indicate a number of bytes that have been received or dropped. The congestion window less outstanding byte count (e.g., outst_bcnt) can indicate a number of bytes available to send to the receiver.

At 308, the sender can determine latency in the path from sender to receiver based on changes in RTT. Changes in RTT can be determined based on differences of multiple received timestamp values in response to notification packets and current timestamp values.

At 310, the sender can adjust the congestion window based on changes in latency. For example, a rising RTT can indicate increasing latency and congestion in the path from sender to receiver. For example, a falling RTT can indicate decreasing latency and congestion in the path from sender to receiver. For example, congestion window size can be increased to a congestion window ceiling based on the RTT being stable or falling. For example, congestion window size can be decreased to a congestion window floor based on a rising RTT.

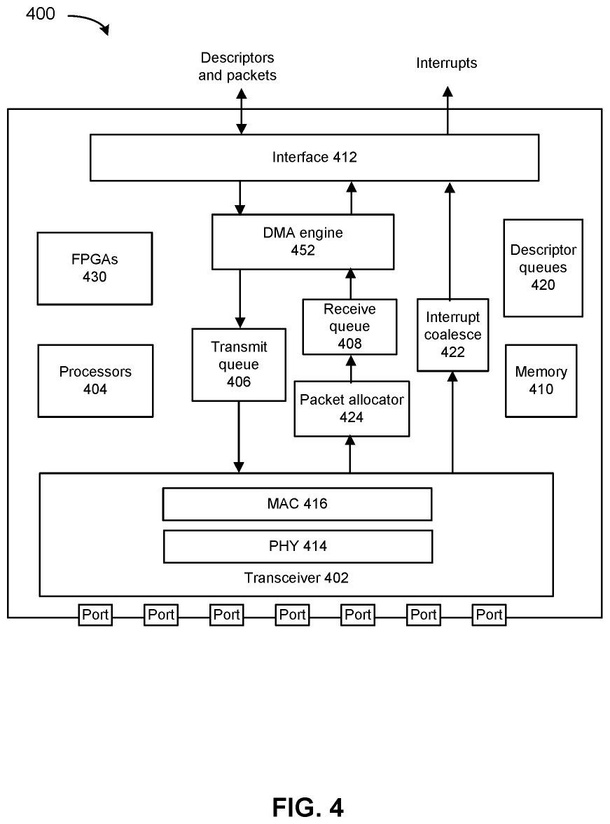

FIG. 4 depicts an example network interface device. In some examples, processors 404 and/or FPGAs 430 can be configured to generate SNPs and/or RNPs (or other packets) to transmit and adjust a congestion window, as described herein. Some examples of network interface 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and bus interface 412, and DMA engine 452. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 414 and media access control (MAC) circuitry 416. PHY circuitry 414 can include encoding and decoding circuitry (not shown) to encode and decode data packets according to applicable physical layer specifications or standards. MAC circuitry 416 can be configured to perform MAC address filtering on received packets, process MAC headers of received packets by verifying data integrity, remove preambles and padding, and provide packet content for processing by higher layers. MAC circuitry 416 can be configured to assemble data to be transmitted into packets, that include destination and source addresses along with network control information and error detection hash values.

Processors 404 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 404.

Processors 404 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 404 can be configured to transmit SNPs and/or RNPs (or other packets) and perform congestion control, as described herein.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 provides this coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be volatile and/or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with or based at least in part on PCI, PCIe, PCI-x, Serial ATA, and/or USB (although other interconnection standards may be used), or proprietary variations thereof.

FIG. 5 depicts a system. The system can use embodiments described herein to configure a network interface device to generate SNPs and/or RNPs (or other packets) to transmit and adjust a congestion window, as described herein. System 500 includes processors 510, which provides processing, operation management, and execution of instructions for system 500. Processors 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processors 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 510 can include one or more processor sockets.

In some examples, interface 512 and/or interface 514 can include a switch (e.g., CXL switch) that provides device interfaces between processors 510 and other devices (e.g., memory subsystem 520, graphics 540, accelerators 542, network interface 550, and so forth). Connections provide between a processor socket of processors 510 and one or more other devices can be configured by a switch controller, as described herein.

In one example, system 500 includes interface 512 coupled to processors 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a programmable or fixed function offload engine that can be accessed or used by a processors 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processors 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Applications 534 and/or processes 536 can refer instead or additionally to a virtual machine (VM), container, microservice, processor, or other software. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processors 510 or a physical part of interface 512. For example, memory controller 522 can be an integrated memory controller, integrated onto a circuit with processors 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others. In some examples, OS 532 and/or a driver can configure network interface 550 to generate SNPs and/or RNPs (or other packets) to transmit and adjust a congestion window, as described herein.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. As described herein, network interface 550 can include a sender network interface that adjusts a transmit rate of packets of a flow based on received congestion metrics. As described herein, network interface 550 can include a receiver network interface that forwards received congestion metrics to a sender network interface device.

In some examples, network interface 550 can be implemented as a network interface controller, network interface card, a host fabric interface (HFI), or host bus adapter (HBA), and such examples can be interchangeable. Network interface 550 can be coupled to one or more servers using a bus, PCIe, CXL, or DDR. Network interface 550 may be embodied as part of a system-on-a-chip (SoC) that includes one or more processors, or included on a multichip package that also contains one or more processors. In some examples, network interface 550 can generate SNPs and/or RNPs (or other packets) to transmit and adjust a congestion window, as described herein.

Some examples of network device 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processors 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processors 510 or can include circuits or logic in processors 510 and interface 514.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

In some examples, system 500 can be implemented using interconnected compute nodes of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Example 1 includes one or more examples and includes an apparatus comprising: a network interface device comprising: circuitry to cause transmission of a packet following transmission of one or more data packets to a receiver, wherein the packet comprises one or more of: a count of transmitted data, a timestamp of transmission of the packet, and/or an index value to one or more of a count of transmitted data and a timestamp of transmission of the packet; circuitry to receive, from the receiver, a second packet that includes a copy of the count of transmitted data and the timestamp of transmission of the packet or the index from the packet; and circuitry to perform congestion control based on the received copy of the count of transmitted data and the timestamp of transmission of the packet.

Example 2 includes one or more examples, wherein the packet is to follow a path of the one or more data packets through one or more routers to the receiver.

Example 3 includes one or more examples, wherein the circuitry to perform congestion control based on the received copy of the count of transmitted data and the timestamp of transmission of the packet is to determine an available amount of data to transmit based on a congestion window and inflight bytes derived from the received copy of the count of transmitted data.

Example 4 includes one or more examples, wherein the circuitry to perform congestion control based on the received copy of the count of transmitted data and the timestamp of transmission of the packet is to limit packet transmission based on the determined available amount of data to transmit.

Example 5 includes one or more examples, wherein the circuitry to perform congestion control based on the received copy of the count of transmitted data and the timestamp of transmission of the packet is to determine latency through a path from the network interface device to the receiver.

Example 6 includes one or more examples, wherein the determine latency through a path from the network interface device to the receiver is based on a current timestamp and the copy of the timestamp of transmission of the packet.

Example 7 includes one or more examples, wherein the circuitry to perform congestion control based on the received copy of the count of transmitted data and the timestamp of transmission of the packet is to increase a congestion window size based on decreasing latency or decrease the congestion window size based on increasing latency.

Example 8 includes one or more examples, wherein the network interface device comprises one or more of: network interface controller (NIC), SmartNIC, router, forwarding element, infrastructure processing unit (IPU), or data processing unit (DPU).

Example 9 includes one or more examples, wherein the copy of the count of transmitted data is adjusted based on bytes received at a receiver during processing of the packet and wherein the timestamp is adjusted based on a time from receipt of the packet to transmission of the second packet by the receiver.

Example 10 includes one or more examples, and includes a computer-readable medium comprising instructions stored thereon, that if executed by one or more processors, cause the one or more processors to: configure circuitry of a network interface device to: perform congestion control by adjustment of a transmit window for both Remote Direct Memory Access (RDMA) read and write operations from a sender.

Example 11 includes one or more examples, wherein the perform congestion control comprises: cause transmission of a packet following transmission of one or more data packets to a receiver, wherein the packet comprises a count of transmitted data and/or a timestamp of transmission of the packet and perform congestion control based on a received copy of the count of transmitted data and a timestamp of transmission of the packet.

Example 12 includes one or more examples, wherein the packet is to follow a path of the one or more data packets through one or more routers to the receiver.

Example 13 includes one or more examples, wherein to perform congestion control based on the received copy of the count of transmitted data and the timestamp of transmission of the packet comprises determine an available amount of data to transmit based on a congestion window and inflight bytes derived from the received copy of the count of transmitted data.

Example 14 includes one or more examples, wherein to perform congestion control based on the received copy of the count of transmitted data and the timestamp of transmission of the packet comprises limit packet transmission based on the determined available amount of data to transmit.

Example 15 includes one or more examples, wherein to perform congestion control based on the received copy of the count of transmitted data and the timestamp of transmission of the packet comprises determine latency through a path from the network interface device to the receiver.

Example 16 includes one or more examples, wherein to perform congestion control based on the received copy of the count of transmitted data and the timestamp of transmission of the packet comprises increase a congestion window size based on decreasing latency or decrease the congestion window size based on increasing latency.

Example 17 includes one or more examples, and includes a method comprising: transmitting a packet following transmission of one or more data packets to a receiver, wherein the packet comprises a count of transmitted data and a timestamp of transmission of the packet; performing congestion control based on a received copy of the count of transmitted data and the timestamp of transmission of the packet.

Example 18 includes one or more examples, wherein the packet is to follow a path of the one or more data packets through one or more routers to the receiver.

Example 19 includes one or more examples, wherein the performing congestion control based on the received copy of the count of transmitted data and the timestamp of transmission of the packet comprising determining an available amount of data to transmit based on a congestion window and the received copy of the count of transmitted data and limiting packet transmission based on the determined available amount of data to transmit.

Example 20 includes one or more examples, wherein the performing congestion control based on the received copy of the count of transmitted data and the timestamp of transmission of the packet comprising: determining latency through a path from a sender to the receiver and increasing a congestion window size based on decreasing latency or decreasing the congestion window size based on increasing latency.

Example 21 includes one or more examples, wherein a network interface device performs the transmitting the packet following transmission of one or more data packets to a receiver and performing congestion control based on a received copy of the count of transmitted data and the timestamp of transmission of the packet.

What is claimed is:

1. An apparatus comprising:
a network interface device comprising:
circuitry to cause transmission of a packet following transmission of one or more data packets to a receiver, wherein the packet comprises one or more of: a count of transmitted data, a timestamp of transmission of the packet, and/or an index value to one or more of a count of transmitted data and a timestamp of transmission of the packet;
circuitry to receive, from the receiver, a second packet that includes a copy of the count of transmitted data and the timestamp of transmission of the packet or the index from the packet; and
circuitry to perform congestion control based on the copy of the count of transmitted data and the timestamp of transmission of the packet.

2. The apparatus of claim 1, wherein the packet is to follow a path of the one or more data packets through one or more routers to the receiver.

3. The apparatus of claim 1, wherein the circuitry to perform congestion control based on the copy of the count of transmitted data and the timestamp of transmission of the packet is to determine an available amount of data to transmit based on a congestion window and inflight bytes derived from the copy of the count of transmitted data.

4. The apparatus of claim 3, wherein the circuitry to perform congestion control based on the copy of the count of transmitted data and the timestamp of transmission of the packet is to limit packet transmission based on the determined available amount of data to transmit.

5. The apparatus of claim 1, wherein the circuitry to perform congestion control based on the copy of the count of transmitted data and the timestamp of transmission of the packet is to determine latency through a path from the network interface device to the receiver.

6. The apparatus of claim 5, wherein the determine latency through a path from the network interface device to the receiver is based on a current timestamp and the copy of the timestamp of transmission of the packet.

7. The apparatus of claim 1, wherein the circuitry to perform congestion control based on the copy of the count of transmitted data and the timestamp of transmission of the packet is to increase a congestion window size based on decreasing latency or decrease the congestion window size based on increasing latency.

8. The apparatus of claim 1, wherein the network interface device comprises one or more of: network interface controller (NIC), SmartNIC, router, forwarding element, infrastructure processing unit (IPU), or data processing unit (DPU).

9. The apparatus of claim 1, wherein the copy of the count of transmitted data is adjusted based on bytes received at a receiver during processing of the packet and wherein the timestamp is adjusted based on a time from receipt of the packet to transmission of the second packet by the receiver.

10. A computer-readable medium comprising instructions stored thereon, that if executed by one or more processors, cause the one or more processors to:
configure circuitry of a network interface device to:
perform congestion control by adjustment of a transmit window for both Remote Direct Memory Access (RDMA) read and write operations from a sender.

11. The computer-readable medium of claim 10, wherein the perform congestion control comprises:
cause transmission of a packet following transmission of one or more data packets to a receiver, wherein the packet comprises a count of transmitted data and/or a timestamp of transmission of the packet and
perform congestion control based on a received copy of the count of transmitted data and a timestamp of transmission of the packet.

12. The computer-readable medium of claim 11, wherein the packet is to follow a path of one or more data packets through one or more routers to a receiver.

13. The computer-readable medium of claim 11, wherein to perform congestion control based on the received copy of the count of transmitted data and the timestamp of transmission of the packet comprises determine an available amount of data to transmit based on a congestion window and inflight bytes derived from the received copy of the count of transmitted data.

14. The computer-readable medium of claim 13, wherein to perform congestion control based on the received copy of the count of transmitted data and the timestamp of transmission of the packet comprises limit packet transmission based on the determined available amount of data to transmit.

15. The computer-readable medium of claim 11, wherein to perform congestion control based on the received copy of the count of transmitted data and the timestamp of transmission of the packet comprises determine latency through a path from the network interface device to the receiver.

16. The computer-readable medium of claim 11, wherein to perform congestion control based on the received copy of the count of transmitted data and the timestamp of transmission of the packet comprises increase a congestion window size based on decreasing latency or decrease the congestion window size based on increasing latency.

17. A method comprising:
transmitting a packet following transmission of one or more data packets to a receiver, wherein the packet comprises a count of transmitted data and a timestamp of transmission of the packet;
performing congestion control based on a received copy of the count of transmitted data and the timestamp of transmission of the packet.

18. The method of claim 17, wherein the packet is to follow a path of the one or more data packets through one or more routers to the receiver.

19. The method of claim 17, wherein the performing congestion control based on the received copy of the count of transmitted data and the timestamp of transmission of the packet comprising determining an available amount of data to transmit based on a congestion window and the received copy of the count of transmitted data and limiting packet transmission based on the determined available amount of data to transmit.

20. The method of claim 17, wherein the performing congestion control based on the received copy of the count of transmitted data and the timestamp of transmission of the packet comprising:
determining latency through a path from a sender to the receiver and
increasing a congestion window size based on decreasing latency or decreasing the congestion window size based on increasing latency.

21. The method of claim 17, wherein a network interface device performs the transmitting the packet following transmission of one or more data packets to a receiver and performing congestion control based on a received copy of the count of transmitted data and the timestamp of transmission of the packet.
